(19) United States
(12) Patent Application Publication
(10) Pub. No.: US 2006/0047589 A1
(43) Pub. Date: Mar. 2, 2006

(54) Investment program contribution system

(75) Inventor: Edward Grau, West Palm Beach, FL (US)

Correspondence Address: EDWARD GRAU, 1466 BROADWAY SUITE 1200, NEW YORK, NY, 10036, US

(73) Assignee: Mr. Edward Grau, West Palm Beach, FL (US)

(21) Appl. No.: 10/711,172

(22) Filed: Aug. 30, 2004

(51) Int. Cl. G06Q 40/00

(52) U.S. Cl. 705/35

(57) ABSTRACT

A system is provided for automatically contributing money to a savings program upon or after making a debit, credit, or stored value card transaction. Included is technology to run a service of providing savings contributions. These systems and methods can be run as a secondary transaction in parallel with the existing transaction or after the transaction is complete in a near-real time or “batch” mode. Also provided is a method and system for signing onto the service, setting individual savings, credit, stored value, and investment account information, setting contribution preferences, updating account settings, billing, and report viewing.

### BACKGROUND OF THE INVENTION

The present invention relates to an improved savings contribution system for automatically contributing money to a savings program upon transacting with a debit, credit, or stored value card without disrupting the initial purchase activity. This present invention method is achieved by allowing the debit, credit, or stored value card transaction to proceed using existing technology and prior art while using the present invention to initiate a secondary transaction to transfer money from the individual's savings, debit, credit, or stored value accounts to the target savings account.

All of the embodiments of the present invention are triggered by an underlying debit, credit, or stored value card transaction, Unlike prior art, all embodiments of the present invention occur after all Point of Sale (POS) activity for said underlying transaction is complete and said underlying transaction is released from all POS technology and accepted by a debit, credit, or stored value card clearinghouse system for routing to an issuer of the debit, credit, or stored value card used in said transaction.

Unlike prior art, none of the embodiments of the present invention require additional functionality within the POS appliance/technology nor are there additional steps in executing said underlying debit, credit or stored value card transaction that will subsequently trigger the present invention. This improved savings contribution system will allow individuals to contribute without disrupting time-sensitive electronic purchase transaction activities or adding the burden to merchant retailers to enhance POS technology, accommodate check-out delays, educate cashiers on additional POS functionality, and provide overall support for the savings program. Also differing from the prior art, the source account(s) of the funds being used for the investment savings contribution could be different from the account used in the underlying transaction triggering the transfer.

The technology and investment process of the present invention reside within the financial institutions providing the credit, debit, or stored value accounts and/or within the central clearinghouse networks for electronic transaction payments. The existing technology and prior art used by these institutions to route and authorize the underlying transaction will remain intact while the process and technology of the present invention will be added to run a separate service of providing savings contributions. These systems and methods can be run in parallel with the existing transaction or after the transaction is complete in a near-real time or “batch” mode.

### DESCRIPTION OF PRIOR ART

The use of integrated financial network systems is known in the prior art. Integrated financial network systems heretofore devised and utilized consist of familiar, expected and obvious structural configurations, notwithstanding various designs encompassed by the prior art which have been developed for the fulfillment of several objectives and requirements. For the purpose of describing the present invention, FIG. 1 illustrates the relevant components of the prior art.

The present invention substantially departs from the conventional concepts and designs of the prior art, as it does not require additional functionality within the POS appliance/technology nor are there additional steps in executing said underlying debit, credit or stored value card transaction that will subsequently trigger the present invention. Unlike prior art, all embodiments of the present invention occur after the transaction is released from all POS technology and accepted by a debit, credit, or stored value card clearinghouse system for routing to an issuer of the debit, credit, or stored value card used in said transaction.

All of the embodiments of the present invention are triggered by an underlying debit, credit, or stored value card transaction.

Unlike prior art, all embodiments of the present invention occur after all Point of Sale (POS) activity for said underlying transaction is complete and said underlying transaction is released from all POS technology and accepted by a debit, credit, or stored value card clearinghouse system for routing to an issuer of the debit, credit, or stored value card used in said pending transaction. Unlike prior art, none of the embodiments of the present invention require additional functionality within the POS appliance/technology nor are there additional steps in executing said underlying debit, credit or stored value card transaction that will subsequently trigger the invention.

### DESCRIPTION OF THE PREFERRED EMBODIMENT

The present invention relates to an improved savings contribution system for automatically contributing money to a savings program upon making an electronic purchase with a debit, credit, or stored value card.

The invention has four preferred embodiments to automatically transfer funds of an individual from a savings or a credit account to a pre-determined investment account of the individual comprising:
(1) Saving information of a completed debit, credit, or stored value card transaction and calculating a fund transfer amount based on this information at some future time;
(2) Interrupting a pending debit, credit, or stored value card transaction after all POS activity is complete and the transaction is in the possession of a card clearinghouse system for routing to the card issuer and determining a fund transfer amount based on the interrupted transaction;
(3) Interrupting a pending debit, credit, or stored value card transaction after a card clearinghouse system has routed the pending transaction the card issuer for a transaction authorization and determining the fund transfer amount based on the interrupted transaction; or
(4) Reading a pending debit, credit, or stored value card transaction after all POS activity is complete and the transaction is in the possession of a card clearinghouse system for routing to the card issuer and triggering a separate request for a fund transfer amount and generating a new fund transfer transaction.

The fund transfer amount is determined in the present invention in one of a plurality of modes dependent on pre-determined investment preferences of the individual including, but not limited to:
(1) the fund transfer amount is a percentage of a sale amount of an individual completed debit, credit, or stored value card transaction;
(2) the fund transfer amount is a percentage of an aggregated sale amount of a plurality of completed debit, credit, or stored value card transactions;
(3) the fund transfer amount is a pre-specified fixed dollar amount for each occurrence of a completed debit, credit, or stored value card transaction;
(4) the fund transfer amount is based on a calculation of a pre-specified fixed dollar amount and total number of occurrences of a plurality of completed debit, credit, or stored value card transactions;
(5) the fund transfer amount is a percentage of a sale amount of an individual pending debit, credit, or stored value card transaction in the hands of a clearinghouse or card issuer;
(6) the fund transfer amount is a pre-specified fixed dollar amount for each individual occurrence of a pending debit, credit, or stored value card transaction in the hands of a clearinghouse or card issuer; or
(7) The fund transfer amount as a specified dollar amount.

Once a fund transfer amount is determined, the present patent has several methods to execute a transfer of the fund transfer amount from said savings or credit account to said pre-determined investment account including:
(1) generating an electronic funds transfer from an account listed in the account information of the individual;
(2) generating a new debit, credit, or smart card transaction against an account specified in the account information; or
(3) adding the fund transfer amount to a pending debit, credit, or stored value transaction amount before resuming the routing or settlement of said pending transaction.

The present invention provides several methods for managing a fund transfer to said pre-determined investment accounts of an individual including:
(1) Temporarily accumulating the fund transfer amount in a demand account until a predetermined completion time or accumulation amount is reached;
(2) Ensuring that said fund transfer will not cause a total balance in the investment account to exceed a predetermined investment account limit;
(3) Ensuring that said fund transfer will not exceed a predetermined maximum contribution amount;
(4) Reducing a fund transfer amount if said fund transfer amount will break a contribution or account limit rule after said fund transfer is complete;
(5) If a fund transfer was reduced, transferring said reduction to a secondary investment account;
(6) Allowing the individual to use one or more investment providers;
(7) Transferring said fund transfer amount to a secondary investment account if said transfer to the first investment account fails;
(8) Allowing a third party to contribute additional monies to the fund transfer amount or the investment account; and
(9) Allowing a third party to accumulate points based on said underlying transaction that can be converted using a predetermined conversion formula towards contributing additional monies to the fund transfer amount or the investment account.

The above description is a broad outline of the main features of the invention. Each of these features in the main embodiments will be described in more detail that will form the subject matter of the claims of this invention. The description of the preferred embodiments only serves to illustrate and clarify aspects of the present invention and does not limit other embodiments and claims made.

The present invention allows an individual to automatically transfer funds from a savings or a credit account to a pre-determined investment account of said individual upon making an electronic purchase with a debit, credit, or stored value card. All of the embodiments of the present invention are triggered by an underlying debit, credit, or stored value card transaction.

The prior art and method of a debit, credit, or stored value card transaction has been illustrated in FIG. 1. Step 1 of FIG. 1 is where an individual initiates a debit, credit, or stored value card transaction and completes all POS entries. For the purpose of describing the present invention, a debit, credit, or stored value transaction begins when an individual initiates a debit, credit, or stored value card transaction. This can occur at a merchant's POS terminal, an Automated Teller Machine (ATM), a transaction made on the internet, a transaction made over a telephone, or a stored value card reader.

After all POS entries are compete and no further input is required by either the individual or the POS technology, a pending transaction exists with a transaction amount, a card type, a card account number, a card issuer code, a merchant account number, and a request to authorize the transaction. This pending transaction is released to a Clearinghouse (Step 2). The clearinghouse reads the card issuer information and routes the pending transaction to the card Issuer (Step 3). Once the pending transaction is received, the Card Issuer reads the account number and compares the transaction amount to a fund balance or available line of credit in the card account of the individual. If a sufficient fund or credit balance exists, the transaction is authorized (Step 4). The card issuer sends an authorization decision and subsequent settlement to Clearinghouse (Step 5). The Clearinghouse routes the authorization decision to the POS system and transfers the settlement to an account at a bank of the merchant (Step 6).

The present invention is designed to allow an individual to automatically transfer funds from a savings or a credit account to a pre-determined investment account of said individual based on the prior method of a debit, credit, or stored value card transaction.

The first preferred embodiment of the invention does not disrupt the debit, credit, or stored value transaction outlined above. Under the first preferred embodiment, after all activity of a debit, credit, or stored value transaction is complete, a copy of said completed transaction is saved. The completed transaction could be saved at a multiple of places including at the Clearinghouse (FIG. 2A Step 7), at the Card Issuer (FIG. 2B Step 7), at the merchant, or by a Third Party receiving completed transaction information from any participants in the underlying transaction (FIG. 2C Step 7).

At a future point in time, the saved transaction information is read along with a set of pre-determined investment preference information of the individual (FIG. 3A Step 1) to calculate a fund transfer amount. The formula to calculate a fund transfer amount depends on the pre-determined investment preference information of the individual. The fund transfer amount can be a percentage of a sale amount for each completed transaction or a fixed dollar amount for each occurrence of a completed transaction. The fund transfer amount is then determined based on an individual completed debit, credit, or stored value card transaction or an aggregate of said completed transactions (FIG. 3A Step 2).

Once the fund transfer amount is determined, a fund transfer transaction is initiated by generating a new debit, credit, or smart card transaction against an account specified in the account information of the individual (FIG. 3A Step 3). The transfer can also be carried out by an electronic transfer of funds from a savings or credit account listed in the account information of the individual.

The Clearinghouse routes the newly generated fund transfer transaction to the Card Issuer (FIG. 3A Step 4) for authorization and settlement.

The Card Issuer compares the transaction amount to the card account of the individual and transaction is authorized or declined (FIG. 3A Step 5). The card issuer sends an authorization decision and subsequent settlement to the Clearinghouse (FIG. 3A Step 6).

The Clearinghouse transfers the fund transfer settlement to an investment account of the individual (FIG. 3A Step 7). The fund transfer amount can also be temporarily accumulated in a demand account until a predetermined completion time or accumulation amount is reached prior to transferring monies to an investment account of the individual.

The first embodiment can also reside in the Card Issuer (FIG. 3B). The steps are similar to those of FIG. 3A without the need to route the fund transfer transaction (FIG. 3A Step 4) or subsequent authorization decision (FIG. 3A Step 6) as said pending transaction is generated by the Card Issuer.

The second preferred embodiment of the present invention does not disrupt the POS activity of the debit, credit, or stored value transaction outlined in FIG. 1 Step 1 and Step 2. Under the second preferred embodiment, an individual initiates said transaction and completes all POS entries (FIG. 4A Step 1). The POS technology creates a pending transaction with a transaction amount, a card type, a card account number, a card issuer code, a merchant account number, and a request to authorize the transaction. This pending transaction is released to a Clearinghouse (FIG. 4A Step 2).

Once said pending transaction is in the possession of said clearinghouse for routing to a Card Issuer, the routing of the pending transaction is interrupted (FIG. 4A Step 3). An account number used in the pending transaction is compared to the saved account information of the individual to determine if two of the said account numbers match (FIG. 4A Step 4).

If a match is found, then a fund transfer amount is calculated (FIG. 4A Step 5) based on a set of investment preference information of the individual and the pending transaction information. The method to calculate a fund transfer amount depends on the investment preference information of the individual. The fund transfer amount can be a percentage of a sale amount of the pending transaction or a fixed dollar amount for each occurrence of a pending transaction.

Once the fund transfer amount is determined, a fund transfer transaction is initiated by generating a new debit, credit, or smart card transaction against an account specified in the account information of the individual (FIG. 4A Step 6). The transfer can also be carried out by an electronic transfer of funds from a savings or credit account listed in the account information of the individual. The pending transaction is also resumed.

The Clearinghouse routes the pending transaction and the fund transfer transaction to the Card Issuer (FIG. 4A Step 7) for authorization and settlement. The Card Issuer compares each transaction amount to the card account of the individual and each transaction is authorized or declined (FIG. 4A Step 8).

The card issuer sends an authorization decision and subsequent settlement to the Clearinghouse for each of the transactions (FIG. 4A Step 9).

The clearinghouse routes the authorization decision to the merchant and settlement of the pending transaction to a bank of the merchant (FIG. 4A Step 10).

The authorization decision and settlement for the fund transfer transaction are received by the computing system of the invention within the Clearinghouse (FIG. 4A Step 11).

The Clearinghouse transfers the fund transfer settlement to an investment account of the individual (FIG. 4A Step 12). The fund transfer amount can also be temporarily accumulated in a demand account until a predetermined completion time or accumulation amount is reached prior to transferring monies to an investment account of the individual.

The third preferred embodiment of the present invention does not disrupt the POS activity of the debit, credit, or stored value transaction outlined in FIG. 1 Step 1 and Step 2 nor does it change the clearinghouse activity outlined in FIG. 1 Step 3 and Step 6. Under the third preferred embodiment, an individual initiates said transaction and completes all POS entries (FIG. 4B Step 1). The POS technology creates a pending transaction with a transaction amount, a card type, a card account number, a card issuer code, a merchant account number, and a request to authorize the transaction. This pending transaction is released to a Clearinghouse (FIG. 4B Step 2).

The clearinghouse reads the card issuer information and routes the pending transaction to the card Issuer (FIG. 4B Step 3). Once the pending transaction in the possession of said Card Issuer, the authorization of the pending transaction is interrupted (FIG. 4B Step 4). An account number used in the pending transaction is compared to the saved account information of the individual to determine if two of the said account numbers match (FIG. 4B Step 5).

If a match is found, then a fund transfer amount is calculated (FIG. 4B Step 6) based on a set of investment preference information of the individual and the pending transaction information. The method to calculate a fund transfer amount depends on the investment preference information of the individual. The fund transfer amount can be a percentage of a sale amount of each pending transaction or a fixed dollar amount for each occurrence of a pending transaction.

Once the fund transfer amount is determined, a fund transfer transaction is initiated by generating a new debit, credit, or smart card transaction against an account specified in the account information of the individual (FIG. 4B Step 7). The transfer can also be carried out by an electronic transfer of funds from a savings or credit account listed in the account information of the individual. The pending transaction is also resumed.

The transaction amounts of the pending transaction and the fund transfer transaction are compared to the card account of the individual and each transaction is authorized or declined (FIG. 4B Step 8).

The card issuer sends an authorization decision and subsequent settlement to the Clearinghouse for the pending transaction (FIG. 4B Step 9).

The clearinghouse routes the authorization decision to the merchant and settlement of the pending transaction to a bank of the merchant (FIG. 4B Step 10).

Card Issuer transfers the fund transfer settlement to an investment account of the individual (FIG. 4B Step 11). The fund transfer amount can also be temporarily accumulated in a demand account until a predetermined completion time or accumulation amount is reached prior to transferring monies to an investment account of the individual.

The fourth preferred embodiment of the present invention does not disrupt the POS activity of the debit, credit, or stored value transaction outlined in FIG. 1 Steps 1 through 6. Under the fourth preferred embodiment, an individual initiates said transaction and completes all POS entries (FIG. 5 Step 1). The POS technology creates a pending transaction with a transaction amount, a card type, a card account number, a card issuer code, a merchant account number, and a request to authorize the transaction. This pending transaction is released to a Clearinghouse (FIG. 5 Step 2).

Once said pending transaction is in the possession of said clearinghouse for routing to a Card Issuer, the pending transaction is read prior to routing to a card issuer (FIG. 5 Step 3).

The clearinghouse reads the card issuer information and routes the pending transaction to the card Issuer (FIG. 5 Step 4). Once the pending transaction is received, the Card Issuer reads the account number and compares the transaction amount to a fund balance or available line of credit in the card account of the individual. If a sufficient fund or credit balance exists, the transaction is authorized (FIG. 5 Step 5). The card issuer sends an authorization decision and subsequent settlement to Clearinghouse (FIG. 5 Step 6). The Clearinghouse routes the authorization decision to the POS system and transfers the settlement to an account at a bank of the merchant (FIG. 5 Step 7).

While the pending transaction is being processed in FIG. 5 Steps 1 through 7, an account number used in the pending transaction is compared to the saved account information of the individual to determine if two of the said account numbers match (FIG. 5 Step 8).

If a match is found, then the Computing system initiates a new transaction and prompts individual to enter a fund transfer amount (FIG. 5 Step 9). At this prompt, the individual chooses to respond and enters a fund transfer amount (FIG. 5 Step 10). The fund transfer amount is sent to the Clearinghouse (FIG. 5 Step 11).

The methods of the present invention (FIG. 5 Steps 9 through 11) differ from the prior art as the underlying transaction (FIG. 5 Steps 1 through 7) is independent and has been released for authorization. The fund transfer amount is optional and is entered as a separate transaction during the typical delay period experienced while the underlying transaction is being authorized. The current method also differs from the prior art as the fund transfer transaction is separate from the underlying transaction with a separate authorization process that occurs at a future point in time after the underlying transaction is complete.

At a future point in time, the fund transfer transaction is initiated by generating a new debit, credit, or smart card transaction against an account specified in the account information of the individual (FIG. 5 Step 12). The transfer can also be carried out by an electronic transfer of funds from a savings or credit account listed in the account information of the individual. Several fund transfer transactions can accumulate and be sent for authorization at a future point in time.

The Clearinghouse routes the fund transfer transaction to the Card Issuer (FIG. 5 Step 13) for authorization and settlement. This step could also be executed by routing the fund transfer transaction to an account in the account information of the individual other than the account used in the underlying transaction. This step could also be executed by generating an electronic funds transfer from an account listed in the account information of the individual rather than generating a new card transaction.

The Card Issuer compares each transaction amount to the card account of the individual and each transaction is authorized or declined (FIG. 5 Step 14).

The card issuer sends an authorization decision and subsequent settlement to the Clearinghouse for the fund transfer transaction (FIG. 5 Step 15).

The authorization decision and settlement for the fund transfer transaction are received by the computing system of the invention within the Clearinghouse (FIG. 5 Step 16). The Clearinghouse transfers the fund transfer settlement to an investment account of the individual (FIG. 5 Step 17). The fund transfer amount can also be temporarily accumulated in a demand account until a predetermined completion time or accumulation amount is reached prior to transferring monies to an investment account of the individual.

All embodiments of the present invention include an ability for an individual to enter and change account information and investment preference information. This information will include debit, credit, or stored value accounts, savings accounts, investment accounts, individual-specific information, investment preferences, rules or limits governing said accounts, account reporting and billing preferences, and other individual information required by the present invention.

All embodiments of the present invention include an ability for the individual to view account balances of total monies in a temporary demand account, a history of completed fund transfer activity, a listing of fees charged, and a history of account activity.

All embodiments of the present invention include an ability for the individual to interact with the present invention via an internet interface, a phone interface, or via a telephone interface.

### BRIEF DESCRIPTION OF THE DRAWINGS

Certain embodiments of the present invention have been illustrated to aid in clarifying the methods and articles of manufacture stated within this document:

FIG. 1: “Prior art and method of a Debit, Credit, or Stored Value card transaction” provides a point of reference for the existing art of a debit, credit, or stored value transaction;

FIG. 2A: “Capturing Completed Transaction Information at the Clearinghouse” illustrates the first preferred embodiment of saving information of a completed debit, credit, or stored value card transaction at a clearinghouse;

FIG. 2B: “Capturing Completed Transaction Information at the Card Issuer” illustrates the first preferred embodiment of saving information of a completed debit, credit, or stored value card transaction at an Issuer of the card used in the said pending transaction;

FIG. 2C: “Capturing Completed Transaction Information at a Third Party” illustrates the first preferred embodiment of saving information of a completed debit, credit, or stored value card transaction by a third party and fed by several sources;

FIG. 3A: “Fund Transfer based on Completed Transaction Data at Clearinghouse” illustrates the first preferred embodiment of calculating a fund transfer amount based on a data store of completed debit, credit, or stored value card transaction information at a clearinghouse and generating a new transaction to an account within the individual's saved account information;

FIG. 3B: “Fund Transfer based on Completed Transaction Data at Card Issuer” illustrates the first preferred embodiment of calculating a fund transfer amount based on a data store of completed debit, credit, or stored value card transaction information at an Issuer of the card used in said pending transaction and generating a new transaction to an account within the individual's saved account information;

FIG. 4A: “Fund Transfer Based on Interrupting Pending Transaction at the Clearinghouse” illustrates the second preferred embodiment of interrupting a pending debit, credit, or stored value card transaction after all POS activity is complete and the transaction is in the possession of a card clearinghouse system for routing to the card issuer. At this point, a fund transfer amount is determine based on the pending transaction;

FIG. 4B: “Fund Transfer Based on Interrupting Pending Transaction at the Card Issuer” illustrates the third preferred embodiment of interrupting a pending debit, credit, or stored value card transaction after a card clearinghouse system has routed the pending transaction the card issuer for a transaction authorization and determining the fund transfer amount based on the interrupted transaction; and

FIG. 5: “Fund Transfer From a Secondary Transaction” illustrates the fourth preferred embodiment of reading a pending debit, credit, or stored value card transaction after all POS activity is complete and the transaction is in the possession of a card clearinghouse system. Here, the pending transaction is not disrupted and a new fund transfer transaction is initiated by prompting the individual to enter a fund transfer amount. The new fund transfer transaction is routed for authorization at some future point in time after the underlying transaction is complete.

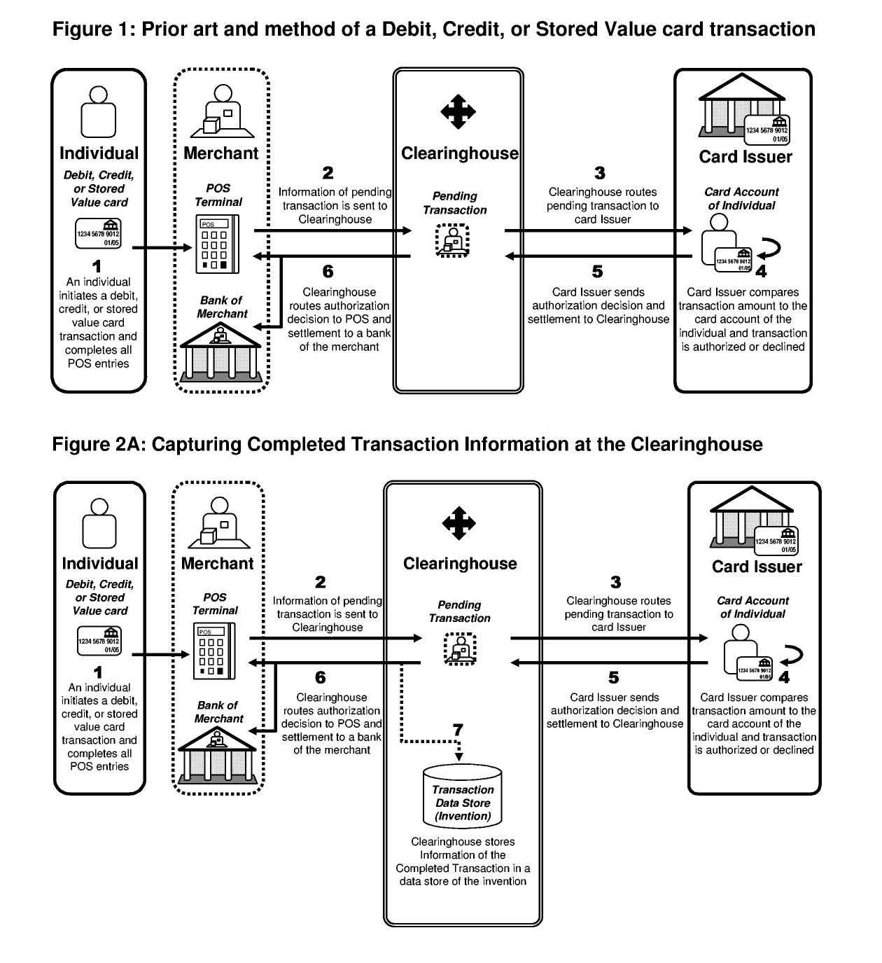

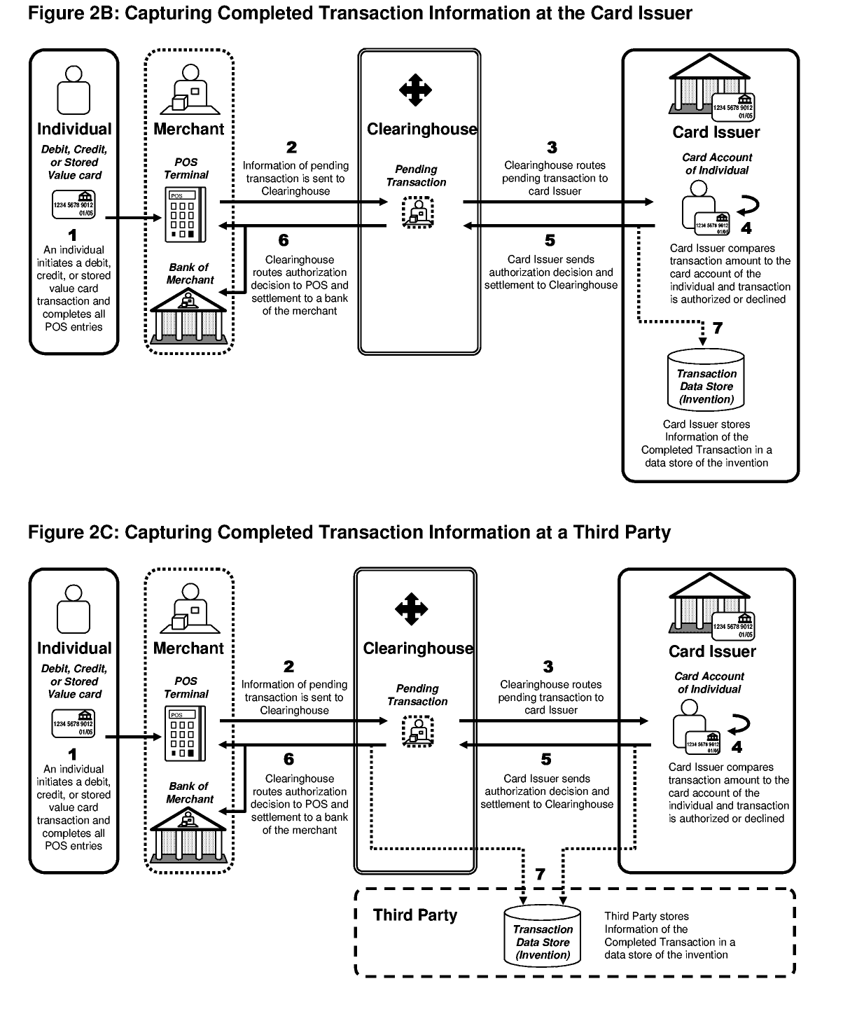

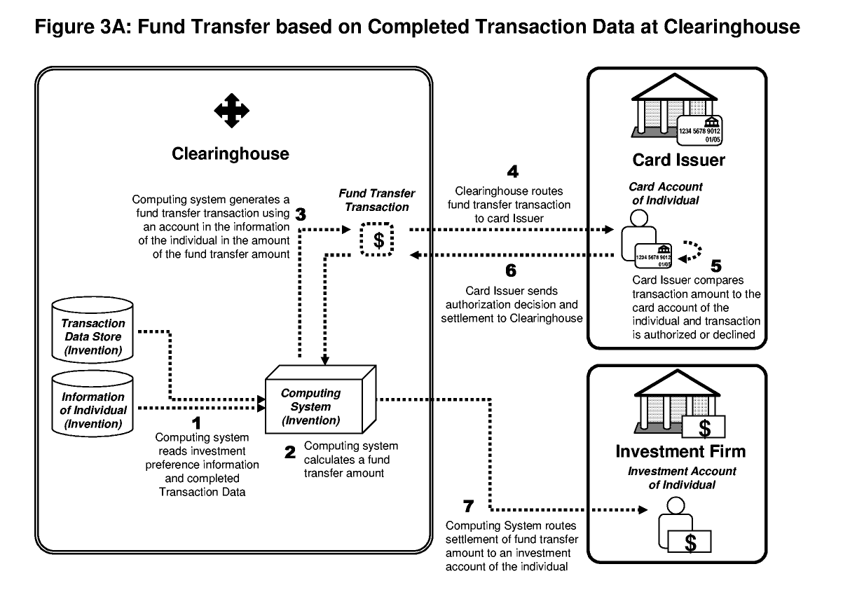

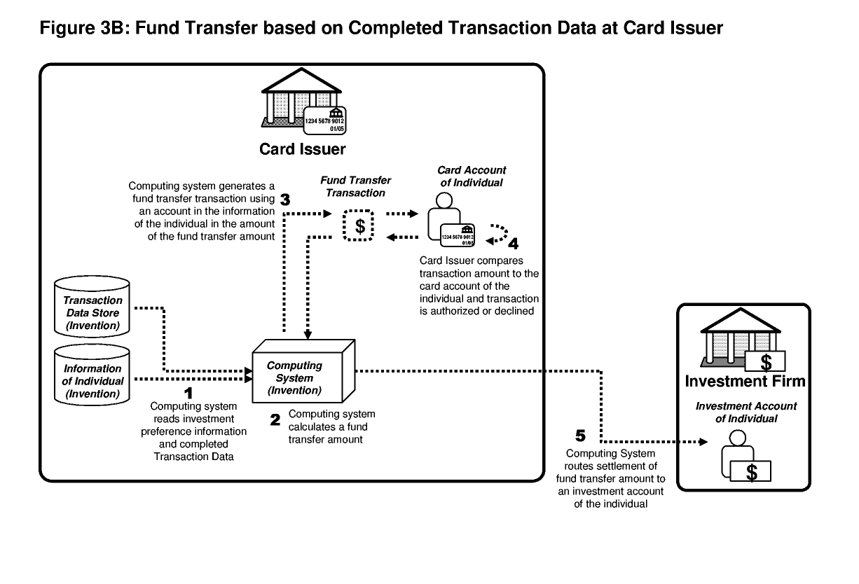

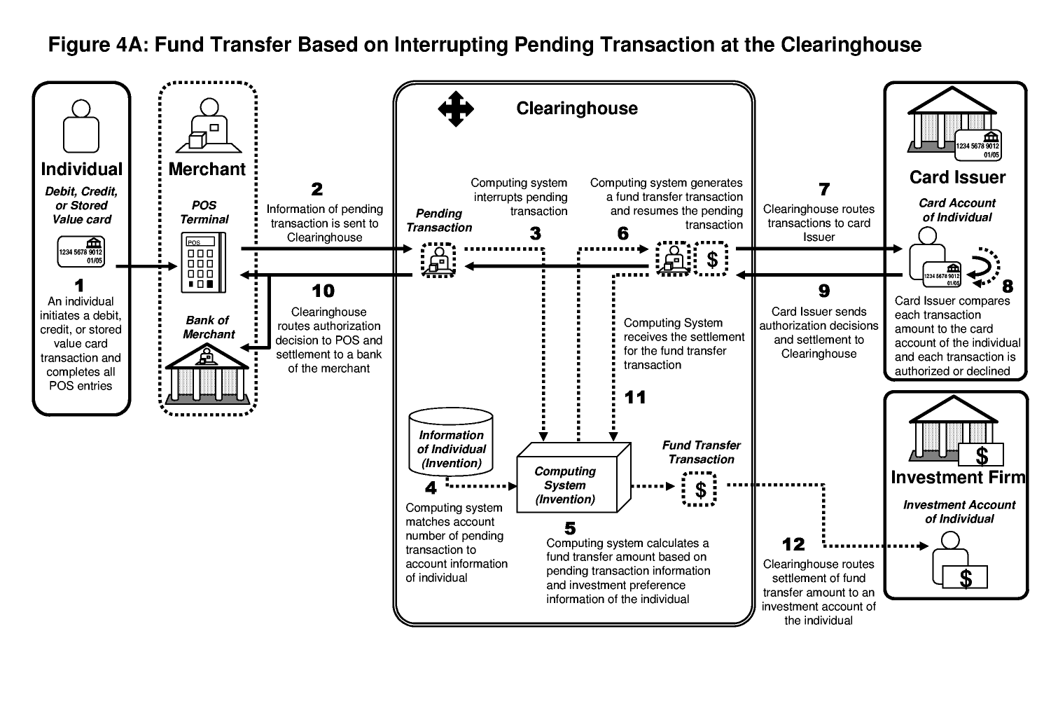

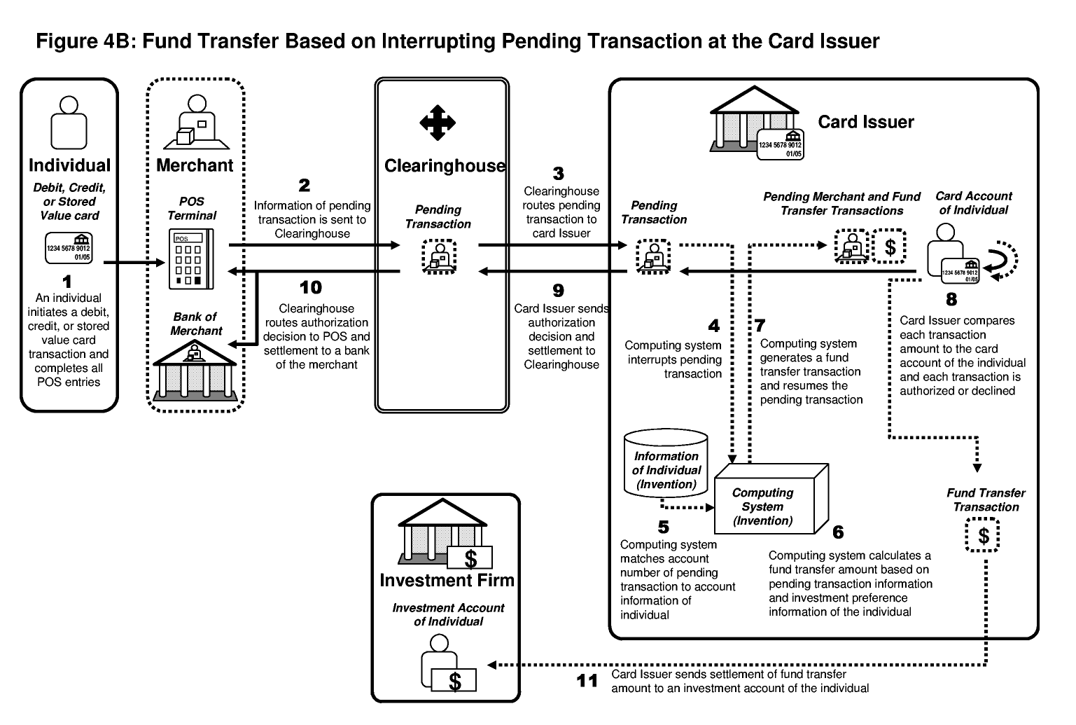

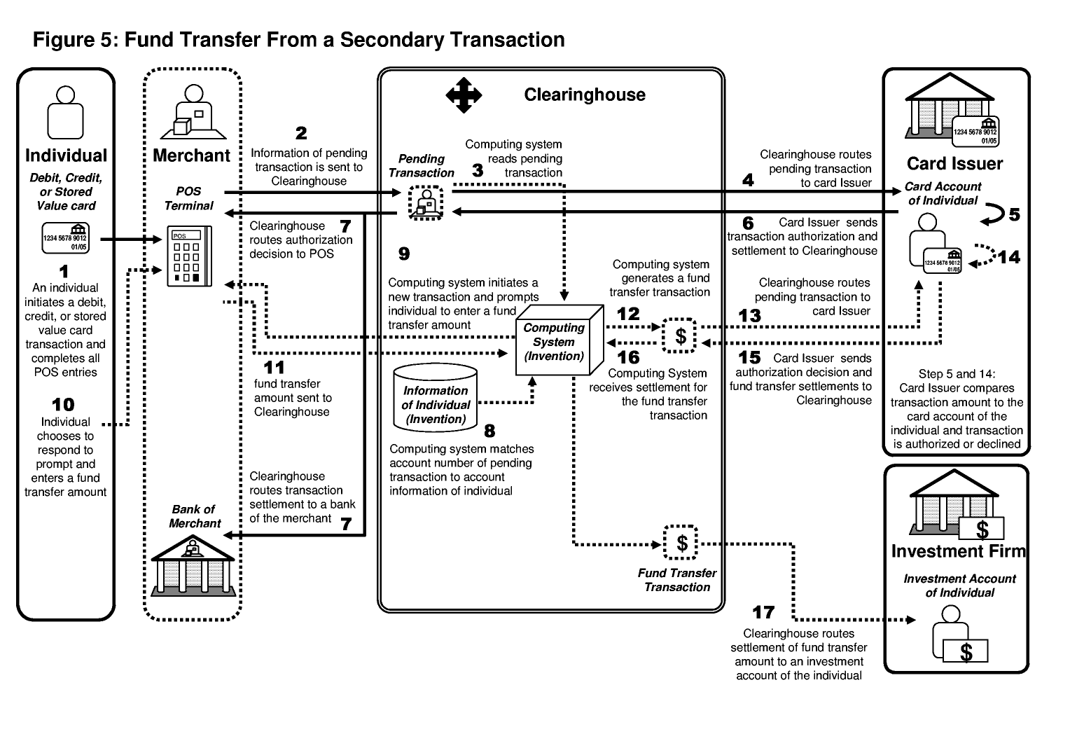

What is claimed is:

1. A method of automatically transferring funds of an individual from a savings or a credit account to a pre-determined investment account of the individual, the method comprising of:
Setting up a system for saving information of the individual including a plurality of:
savings account information;
credit account information;
investment account information;
debit, credit, or stored value card information; and
investment preference information;
Setting up a system for automatically receiving and saving a completed debit, credit, or stored value card transaction information made by an individual;
Calculating a fund transfer amount based on the investment preference information and any information of the completed debit, credit, or stored value card transaction.

2. The method of claim 1 additionally comprising the step of withdrawing the fund transfer amount from an account specified in the account information by an electronic funds transfer.

3. The method of claim 1 additionally comprising the step of temporarily accumulating the fund transfer amount in a demand account until a predetermined completion time.

4. The method of claim 1 additionally comprising the step of temporarily accumulating the fund transfer amount in a demand account until a predetermined accumulation amount.

5. The method of claim 1 further comprising the steps of:
comparing the fund transfer amount to a predetermined transfer limit; and
canceling a fund transfer if completion of said fund transfer will cause a total balance in the investment account to exceed a predetermined investment account limit.

6. The method of claim 1 further comprising the steps of:
Determining an available space in the investment account by comparing an investment account total to a predetermined investment account limit; and
determining if the fund transfer amount is in excess of said available space.

7. The method of claim 6 additionally comprising the step wherein the fund transfer amount is reduced to an amount that will not result in the investment account exceeding the investment account limit after a fund transfer is complete.

8. The method of claim 7 additionally comprising the step wherein said reduction in the fund transfer amount is transferred to a secondary investment account.

9. The method of claim 1 wherein the investment preference information includes an investment total and a predetermined investment limit.

10. The method of claim 1 additionally comprising the step of withdrawing the fund transfer amount from an account specified in the account information as a debit, credit, or smart card transaction.

11. The method of claim 1 additionally comprising the step of withdrawing the fund transfer amount from a debit, credit, or smart card used in the original completed transaction.

12. The method of claim 1 additionally comprising:
receiving a request from the individual to make an investment in a first investment account, wherein the first investment account is designated by the individual as a primary investment account;
determining whether making the investment in the first investment account violates at least one predetermined rule relating to the first investment account; and
automatically contributing at least a portion of the investment into a second investment account designated by the individual as a secondary investment account, if making the investment in the first investment account violates said at least one predetermined rule.

13. The method of claim 12, further comprising:
accessing information received from the individual for designating the first investment account as primary and the second investment account as secondary.

14. The method of claim 13, wherein the first investment account is managed by a first investment provider and the second investment account is managed by a second investment provider.

15. The method of claim 12, wherein the predetermined rule is a maximum investment account value.

16. The method of claim 12, wherein the predetermined rule is a maximum contribution amount.

17. The method of claim 12, wherein the predetermined rule is violated if making the investment in the first investment account fails.

18. The method of claim 17, further comprising:
contributing at least a portion of the investment into the first investment account, if making the investment in the first investment account does not violate at least one predetermined rule.

19. The method of claim 1 wherein the fund transfer amount is a percentage of an aggregated sale amount of the completed debit, credit, or stored value card transactions.

20. The method of claim 1 wherein the fund transfer amount is a percentage of a sale amount of the individual completed debit, credit, or stored value card transactions.

21. The method of claim 1 wherein the fund transfer amount is a pre-specified fixed dollar amount for each occurrence of the completed debit, credit, or stored value card transaction.

22. The method of claim 1 wherein the fund transfer amount is based on a calculation of a pre-specified fixed dollar amount and total number of occurrences of the completed debit, credit, or stored value card transactions.

23. A method of automatically transferring funds of an individual from a savings or credit account to a pre-determined investment account of the individual, the method comprising of:
Setting up a system for saving information of the individual including a plurality of:
savings account information;
credit account information;
investment account information;
debit, credit, or stored value card information; and
investment preference information;
Setting up a system to receive a pending debit, credit, or stored value card transaction of the individual after said pending transaction is released by a Point of Sale (POS) system and accepted by a debit, credit, or stored value card clearinghouse system for a subsequent routing to an issuer of the debit, credit, or stored value card used in said pending transaction;
Setting up a system to automatically interrupt said pending transaction;
Setting up a system to read a card or account number used in said pending transaction; comparing said card or account number to the saved debit, credit, or stored value account information of the individual; and determining if said card or account number matches the saved debit, credit, or stored value account information of the individual; and
Calculating a fund transfer amount based on the investment preference information of the individual and any information in said pending transaction.

24. The method of claim 23 additionally comprising the step of adding the fund transfer amount to a transaction amount contained in the pending transaction, creating a new transaction in the amount of this sum total, and routing the new transaction to the issuer of the debit, credit, or stored value card used in the original pending transaction for authorization and settlement.

25. The method of claim 24 additionally comprising the step of receiving an authorization for the new transaction from the card issuer and routing an authorization for the original pending transaction back to the POS system.

26. The method of claim 25 additionally comprising the step of receiving settlement for the new transaction from the card issuer; splitting said settlement into the pending transaction amount and the fund transfer amount; routing the settlement for the pending transaction amount to a settlement account of the POS system; and routing the settlement for the fund transfer amount to an investment account of the individual.

27. The method of claim 23 additionally comprising the step of withdrawing the fund transfer amount from an account specified in the account information by creating a separate debit, credit, or stored value transaction.

28. The method of claim 23 additionally comprising the step of withdrawing the fund transfer amount from an account specified in the account information by a separate electronic funds transfer.

29. The method of claim 23 additionally comprising the step of temporarily accumulating the fund transfer amount in a demand account until a predetermined completion time.

30. The method of claim 23 additionally comprising the step of temporarily accumulating the fund transfer amount in a demand account until a predetermined accumulation amount.

31. The method of claim 23 further comprising the steps of:
comparing a transfer amount to a predetermined transfer limit; and
canceling a fund transfer if completion of said fund transfer will cause a total balance in the investment account to exceed a predetermined investment account limit.

32. The method of claim 23 further comprising the steps of:
Determining an available space in the investment account by comparing an investment account total to a predetermined investment account limit; and
determining if the fund transfer amount is in excess of said available space.

33. The method of claim 32 additionally comprising the step wherein the fund transfer amount is reduced to an amount that will not result in the investment account exceeding the investment account limit after a fund transfer is complete.

34. The method of claim 32 additionally comprising the step wherein said reduction in the fund transfer amount is transferred to a secondary investment account.

35. The method of claim 23 wherein the investment preference information includes an investment total and a predetermined investment limit.

36. The method of claim 23 additionally comprising the step of withdrawing the fund transfer amount from an account specified in the account information as a debit, credit, or smart card transaction.

37. The method of claim 23 additionally comprising the step of withdrawing the fund transfer amount from a debit, credit, or smart card used in the original completed transaction.

38. A method of claim 23 additionally comprising:
receiving a request from the individual to make an investment in a first investment account, wherein the first investment account is designated by the individual as a primary investment account;
determining whether making the investment in the first investment account violates at least one predetermined rule relating to the first investment account; and
automatically contributing at least a portion of the investment into a second investment account designated by the individual as a secondary investment account, if making the investment in the first investment account violates said at least one predetermined rule.

39. The method of claim 38, further comprising:
accessing information received from the individual for designating the first investment account as primary and the second investment account as secondary.

40. The method of claim 39, wherein the first investment account is managed by a first investment provider and the second investment account is managed by a second investment provider.

41. The method of claim 40, wherein the predetermined rule is a maximum investment account value.

42. The method of claim 40, wherein the predetermined rule is a maximum contribution amount.

43. The method of claim 40, wherein the predetermined rule is violated if making the investment in the first investment account fails.

44. The method of claim 43, further comprising:
contributing at least a portion of the investment into the first investment account, if making the investment in the first investment account does not violate said at least one predetermined rule.

45. The method of claim 23 wherein the fund transfer amount is a percentage of a sale amount of said pending transaction.

46. The method of claim 23 wherein the fund transfer amount is a pre-specified fixed dollar amount for each occurrence of said pending transaction.

47. A method of automatically transferring funds of an individual from a savings or credit account to a pre-determined investment account of the individual, the method comprising of:
Setting up a system for saving information of the individual including a plurality of:
savings account information;
credit account information;
investment account information;
debit, credit, or stored value card information; and
investment preference information;
Setting up a system to receive a pending debit, credit, or stored value card transaction of the individual after said pending transaction is released from a debit, credit, or stored value card clearinghouse and accepted by a debit, credit, or stored value issuer of the said card used in said pending transaction prior to a transaction authorization;
Setting up a system to automatically interrupt said pending transaction;
Setting up a system to read a card or account number used in said pending transaction; comparing said card or account number to the saved debit, credit, or stored value account information of the individual; and determining if said card or account number matches the saved debit, credit, or stored value account information of the individual; and
Calculating a fund transfer amount based on the investment preference information of the individual and any information in said pending transaction.

48. The method of claim 47 additionally comprising the step of adding the fund transfer amount to a transaction amount contained in the pending transaction, creating a new transaction in the amount of this sum total, and routing the new transaction to the issuer of the debit, credit, or stored value card used in the original pending transaction for authorization and settlement.

49. The method of claim 48 additionally comprising the step of splitting the settlement for the new transaction amount into the pending transaction amount and the fund transfer amount; routing the settlement for the pending transaction amount back to the debit, credit, or stored value card clearinghouse system; and routing the settlement for the fund transfer amount to an investment account of the individual.

50. The method of claim 47 additionally comprising the step of withdrawing the fund transfer amount from an account specified in the account information by creating a separate debit, credit, or stored value transaction.

51. The method of claim 47 additionally comprising the step of withdrawing the fund transfer amount from an account specified in the account information by a separate electronic funds transfer.

52. The method of claim 47 additionally comprising the step of temporarily accumulating the fund transfer amount in a demand account until a predetermined completion time.

53. The method of claim 47 additionally comprising the step of temporarily accumulating the fund transfer amount in a demand account until a predetermined accumulation amount.

54. The method of claim 47 further comprising the steps of:
comparing a transfer amount to a predetermined transfer limit; and
canceling a fund transfer if completion of said fund transfer will cause a total balance in the investment account to exceed a predetermined investment account limit.

55. The method of claim 47 further comprising the steps of:
Determining an available space in the investment account by comparing an investment account total to a predetermined investment account limit; and
determining if the fund transfer amount is in excess of said available space.

56. The method of claim 55 additionally comprising the step wherein the fund transfer amount is reduced to an amount that will not result in the investment account exceeding the investment account limit after a fund transfer is complete.

57. The method of claim 55 additionally comprising the step wherein said reduction in the fund transfer amount is transferred to a secondary investment account.

58. The method of claim 47 wherein the investment preference information includes an investment total and a predetermined investment limit.

59. The method of claim 47 additionally comprising the step of withdrawing the fund transfer amount from an account specified in the account information as a debit, credit, or smart card transaction.

60. The method of claim 47 additionally comprising the step of withdrawing the fund transfer amount from a debit, credit, or smart card used in the original completed transaction.

61. A method of claim 47 additionally comprising:
receiving a request from the individual to make an investment in a first investment account, wherein the first investment account is designated by the individual as a primary investment account;
determining whether making the investment in the first investment account violates at least one predetermined rule relating to the first investment account; and
automatically contributing at least a portion of the investment into a second investment account designated by the individual as a secondary investment account, if making the investment in the first investment account violates said at least one predetermined rule.

62. The method of claim 61, further comprising:
accessing information received from the individual for designating the first investment account as primary and the second investment account as secondary.

63. The method of claim 62, wherein the first investment account is managed by a first investment provider and the second investment account is managed by a second investment provider.

64. The method of claim 63, wherein the predetermined rule is a maximum investment account value.

65. The method of claim 63, wherein the predetermined rule is a maximum contribution amount.

66. The method of claim 63, wherein the predetermined rule is violated if making the investment in the first investment account fails.

67. The method of claim 66, further comprising:
contributing at least a portion of the investment into the first investment account, if making the investment in the first investment account does not violate said at least one predetermined rule.

68. The method of claim 47 wherein the fund transfer amount is a percentage of a sale amount of the said pending transaction.

69. The method of claim 47 wherein the fund transfer amount is a pre-specified fixed dollar amount for each occurrence of said pending transaction.

70. A method as in claim 1 additionally comprising a third party contributing additional monies to the fund transfer amount based on said completed debit, credit, or stored value card transaction information.

71. A method as in claim 1 additionally comprising a third party accumulating points based on said completed debit, credit, or stored value card transaction information that can be converted using a predetermined conversion formula towards contributing additional monies to the fund transfer amount at a predetermined completion time or a predetermined completion amount.

72. A method as in claim 1 additionally comprising a third party contributing additional monies to the investment account of the individual based on said completed debit, credit, or stored value card transaction information.

73. A method as in claim 1 additionally comprising a third party accumulating points based on said completed debit, credit, or stored value card transaction information that can be converted using a predetermined conversion formula towards contributing additional monies to the investment account of the individual at a predetermined completion time or a predetermined completion amount.

74. A method as in claim 23 additionally comprising a third party contributing additional monies to the fund transfer amount based on said pending transaction information.

75. A method as in claim 23 additionally comprising a third party accumulating points based on said pending transaction information that can be converted using a predetermined conversion formula towards contributing additional monies to the fund transfer amount at a predetermined completion time or a predetermined completion amount.

76. A method as in claim 23 additionally comprising a third party contributing additional monies to the investment account of the individual based on said pending transaction information.

77. A method as in claim 23 additionally comprising a third party accumulating points based on said pending transaction information that can be converted using a predetermined conversion formula towards contributing additional monies to the investment account of the individual at a predetermined completion time or a predetermined completion amount.

78. A method as in claim 47 additionally comprising a third party contributing additional monies to the fund transfer amount based on said pending transaction information.

79. A method as in claim 47 additionally comprising a third party accumulating points based on said pending transaction information that can be converted using a predetermined conversion formula towards contributing additional monies to the fund transfer amount at a predetermined completion time or a predetermined completion amount.

80. A method as in claim 47 additionally comprising a third party contributing additional monies to the investment account of the individual based on said pending transaction information.

81. A method as in claim 47 additionally comprising a third party accumulating points based on said pending transaction information that can be converted using a predetermined conversion formula towards contributing additional monies to the investment account of the individual at a predetermined completion time or a predetermined completion amount.

82. An article of manufacture for a computer usable program code and computing means for automatically transferring funds from a deposit account of an individual to a savings program account of the individual, comprising of:
A computer usable program code for allowing an individual to enter and save:
a plurality of deposit account information;
a plurality of savings account information;
a plurality of investment account information;
a plurality of debit, credit, or stored value card information; and
a set of investment preference information;
A computer usable program code for automatically receiving and accumulating a completed debit, credit, or stored value card transaction information made by an individual; and
A computer usable program code for calculating a fund transfer amount based on the investment preference information and said completed debit, credit, or stored value card transaction information.

83. An article of manufacture for a computer usable program code and computing means for automatically transferring funds from a deposit account of an individual to a savings program account of the individual, comprising of:
A computer usable program code for allowing an individual to enter and save:
a plurality of deposit account information;
a plurality of savings account information;
a plurality of investment account information;
a plurality of debit, credit, or stored value card information; and
a set of investment preference information;
A computer usable program code and system for causing a computer to receive an electronic signal for a pending debit, credit, or stored value card transaction of the individual after said pending transaction is released by a Point of Sale system and accepted by a debit, credit, or stored value card clearinghouse system for routing to an issuer of the debit, credit, or stored value card used in said pending transaction;
A computer usable program code and system for automatically interrupting said pending transaction of the individual;
A computer usable program code for causing a computer to automatically read a card or account number used in said pending transaction, compare said card or account number to an account number in the pre-determined account information of the individual; and determine if said card or account number used in said pending transaction matches the pre-determined account information of the individual; and
A computer usable program code for calculating a fund transfer amount based on the investment preference information and any information in said pending transaction.

84. An article of manufacture for a computer usable program code and computing means for automatically transferring funds from a deposit account of an individual to a savings program account of the individual, comprising of:
A computer usable program code for allowing an individual to enter and save:
a plurality of deposit account information;
a plurality of savings account information;
a plurality of investment account information;
a plurality of debit, credit, or stored value card information; and
a set of investment preference information;
A computer usable program code and system for causing a computer to receive an electronic signal for a pending debit, credit, or stored value card transaction of the individual after said pending transaction is released from a debit, credit, or stored value card clearinghouse system and accepted by a debit, credit, or stored value issuer of the card used in said pending transaction for authorization;
A computer usable program code and system for automatically interrupting said pending transaction;
A computer usable program code for causing a computer to automatically read a card or account number used in said pending transaction, compare said card or account number to an account number in the pre-determined account information of the individual; and determine if said card or account number used in said pending transaction matches the pre-determined account information of the individual; and
A computer usable program code for calculating a fund transfer amount based on the investment preference information and any information in said pending transaction.

85. An article of manufacture as set forth in claim 82 wherein the computer usable program code for calculating a fund transfer amount is further adapted to generate a signal to withdraw the fund transfer amount from an account specified in the account information of the individual by electronically transferring funds.

86. An article of manufacture as set forth in claim 84 wherein the computer usable program code for calculating a fund transfer amount is further adapted to generate a fund transfer transaction and submit the fund transfer transaction to a credit, debit, or stored value card account listed in the account information of the individual.

87. An article of manufacture as set forth in claim 86 wherein the computer usable program code for generating the fund transfer transaction is further adapted to automatically accept a fund transfer transaction authorization and a fund transfer transaction settlement and store the transaction settlement in a temporary demand account until a predetermined accumulation amount.

88. An article of manufacture as set forth in claim 86 wherein the computer usable program code for generating the fund transfer transaction is further adapted to automatically accept a fund transfer transaction authorization and a fund transfer transaction settlement and store the transaction settlement in a temporary demand account until a predetermined completion time.

89. An article of manufacture as set forth in claim 82 wherein the computer usable program code for allowing an individual to enter account information and investment preference information is responsive to entries for changes in said information.

90. An article of manufacture as set forth in claim 82 additionally comprising of an ability to store data for:
a plurality of completed debit, credit, or stored value card transaction information;
a plurality of individual account information and investment preference information;
a log of completed fund transfer activity;
a log of fund transfer information;
a balance of monies in a temporary demand account;
a log of fees charged; and
a history of account activity.

91. An article of manufacture as set forth in claim 82 wherein the computer usable program code for allowing an individual to enter account information and investment preference information is further adapted to allow the individual to view:
a balance of total monies in a temporary demand account;
a history of completed fund transfer activity;
a listing of fees charged; and
a history of account activity.

92. An article of manufacture as set forth in claim 82 wherein the computer usable program code for automatically receiving and accumulating a completed debit, credit, or stored value card transaction information made by an individual additionally comprises of receiving and accumulating a plurality of completed debit, credit, or stored value card transaction information.

93. An article of manufacture as set forth in claim 82 wherein the computer usable program code for calculating a fund transfer amount from the deposit account to the savings account based on the investment preference information and the completed debit, credit, or stored value card transaction information additionally comprises of calculating a fund transfer amount from the deposit account to the savings account based on the investment preference information and an aggregate of a plurality of completed debit, credit, or stored value card transaction information.

94. An article of manufacture as set forth in claim 83 wherein the computer usable program code for calculating a fund transfer amount is further adapted to generate a signal to withdraw the fund transfer amount from an account specified in the account information of the individual by electronically transferring funds.

95. An article of manufacture as set forth in claim 83 wherein the computer usable program code for calculating a fund transfer amount is further adapted to generate a new fund transfer debit, credit, or stored value card transaction and submit said fund transfer transaction to a credit, debit, or stored value card account listed in the account information of the individual.

96. An article of manufacture as set forth in claim 95 wherein the computer usable program code for generating the fund transfer transaction is further adapted to automatically accept a fund transfer transaction authorization and a fund transfer transaction settlement and store the transaction settlement in a temporary demand account until a predetermined accumulation amount.

97. An article of manufacture as set forth in claim 95 wherein the computer usable program code for generating the fund transfer transaction is further adapted to automatically accept a fund transfer transaction authorization and a fund transfer transaction settlement and store the transaction settlement in a temporary demand account until a predetermined completion time.

98. An article of manufacture as set forth in claim 83 wherein the computer usable program code for allowing an individual to enter account information and investment preference information is responsive to entries for changes in said information.

99. An article of manufacture as set forth in claim 83 additionally comprising of an ability to store data for;
a plurality of pending transaction information;
a plurality of individual account information and investment preference information;
a log of completed fund transfer activity;
a log of fund transfer information;
a balance of monies in a temporary demand account;
a log of fees charged; and
a history of account activity.

100. An article of manufacture as set forth in claim 83 wherein the computer usable program code for allowing an individual to enter account information and investment preference information is further adapted to allow the individual to view;
a balance of total monies in a temporary demand account;
a history of completed fund transfer activity;
a listing of fees charged; and
a history of account activity.

101. An article of manufacture as set forth in claim 84 wherein the computer usable program code for calculating a fund transfer amount is further adapted to generate a signal to withdraw the fund transfer amount from an account specified in the account information of the individual by electronically transferring funds.

102. An article of manufacture as set forth in claim 83 wherein the computer usable program code for calculating a fund transfer amount is further adapted to generate a new fund transfer debit, credit, or stored value card transaction and submit said fund transfer transaction to a credit, debit, or stored value card account listed in the account information of the individual.

103. An article of manufacture as set forth in claim 102 wherein the computer usable program code for generating the new fund transfer transaction is further adapted to automatically accept a fund transfer transaction authorization and a fund transfer transaction settlement and store the fund transfer transaction settlement in a temporary demand account until a predetermined accumulation amount.

104. An article of manufacture as set forth in claim 102 wherein the computer usable program code for generating a new debit, credit, or stored value card transaction is further adapted to automatically accept a transaction response and a transaction settlement and store the transaction settlement in a temporary demand account until a predetermined completion time.

105. An article of manufacture as set forth in claim 84 wherein the computer usable program code for allowing an individual to enter account information and investment preference information is responsive to entries for changes in said information.

106. An article of manufacture as set forth in claim 84 additionally comprising of an ability to store data for;
a plurality of pending debit, credit, or stored value card transaction information;
a plurality of individual account information and investment preference information;
a log of completed fund transfer activity;
a log of fund transfer information;
a balance of monies in a temporary demand account;
a log of fees charged; and
a history of account activity.

107. An article of manufacture as set forth in claim 84 wherein the computer usable program code for allowing an individual to enter account information and investment preference information is further adapted to allow the individual to view;
a balance of total monies in a temporary demand account;
a history of completed fund transfer activity;
a listing of fees charged; and
a history of account activity.

108. A method as in claim 1 wherein said completed debit, credit, or stored value card transaction information includes a transaction made at a merchant Point of Sale (POS) terminal.

109. A method as in claim 1 wherein said completed debit, credit, or stored value card transaction information includes a transaction made at an Automated Teller Machine (ATM).

110. A method as in claim 1 wherein said completed debit, credit, or stored value card transaction information includes a transaction made on the internet.

111. A method as in claim 1 wherein said completed debit, credit, or stored value card transaction information includes a transaction made over a telephone.

112. A method as in claim 1 wherein said pending transaction information includes a transaction made at a stored value card reader.

113. A method as in claim 23 wherein said pending transaction information includes a transaction made at a merchant Point of Sale (POS) terminal.

114. A method as in claim 23 wherein said pending transaction information includes a transaction made at an Automated Teller Machine (ATM).

115. A method as in claim 23 wherein said pending transaction information includes a transaction made on the internet.

116. A method as in claim 23 wherein said pending transaction information includes a transaction made over a telephone.

117. A method as in claim 23 wherein said pending transaction information includes a transaction made at a stored value card reader.

118. A method as in claim 47 wherein said pending transaction information includes a transaction made at a merchant Point of Sale (POS) terminal.

119. A method as in claim 47 wherein said pending transaction information includes a transaction made at an Automated Teller Machine (ATM).

120. A method as in claim 47 wherein said pending transaction information includes a transaction made on the internet.

121. A method as in claim 47 wherein said pending transaction information includes a transaction made over a telephone.

122. A method as in claim 47 wherein said pending transaction information includes a transaction made at a stored value card reader.

123. A method as in claim 23 wherein the system to automatically interrupt said pending transaction is configured to automatically read said pending transaction without interrupting the routing of said pending transaction.

124. A method as in claim 23 wherein the step to calculate a fund transfer amount is configured to generate a new fund transfer transaction.

125. A method of claim 124 additionally comprising the step of prompting the individual to enter a fund transfer amount for the fund transfer transaction.

126. The method of claim 125 additionally comprising the step of routing the fund transfer transaction to the issuer of the debit, credit, or stored value card used in the original pending transaction for authorization and settlement.

127. The method of claim 126 additionally comprising the step of receiving settlement for the fund transfer transaction from the card issuer and routing the settlement for the fund transfer amount to an investment account of the individual.

128. The method of claim 126 wherein the step of routing the fund transfer transaction to the issuer of the debit, credit, or stored value card used in the original pending transaction is replaced by withdrawing the fund transfer amount from an account specified in the account information by a separate electronic funds transfer.

129. An article of manufacture as set forth in claim 83 wherein the computer usable program code and system for automatically interrupting said pending transaction of the individual is configured to automatically read said pending transaction without interrupting the routing of said pending transaction.

130. An article of manufacture as set forth in claim 83 wherein the computer usable program code and system for calculating a fund transfer amount is configured to generate a new fund transfer transaction.

131. An article of manufacture as set forth in claim 130 wherein the computer usable program code and system if further adapted to prompt the individual to enter a fund transfer amount for the fund transfer transaction.
